(19) United States
(12) Patent Application Publication
(10) Pub. No.: US 2019/0366288 A1
(43) Pub. Date: Dec. 5, 2019

(54) METHOD AND INSTALLATION FOR HEAT RECOVERY IN FLUIDISED BED GRANULATION

(71) Applicants: THYSSENKRUPP INDUSTRIAL SOLUTIONS AG, Essen (DE); THYSSENKRUPP AG, Essen (DE)

(72) Inventors: Peter BANIK, Waltrop (DE); Jens MATHIAK, Castrop-Rauxel (DE)

(73) Assignees: thyssenkrupp Industrial Solutions AG, Essen (DE); thyssenkrupp AG, Essen (DE)

(21) Appl. No.: 16/477,950

(22) PCT Filed: Jan. 18, 2018
(86) PCT No.: PCT/EP2018/051212

§ 371 Date: Jul. 15, 2019

(30) Foreign Application Priority Data
Jan. 25, 2017 (DE) 10 2017 201 182.3

(51) Int. Cl. B01J 2/16; B01J 8/18

(52) U.S. Cl. CPC B01J 2/16; B01J 8/1818

(57) ABSTRACT

A process for producing granulated fertilizer by fluidized-bed granulation in a fluidized-bed granulator may involve drawing in and heating air used for fluidization in the fluidized bed via a conduit before entry into the fluidized-bed granulator. Hot exhaust air exiting the fluidized-bed granulator may be obtained, and a substream of the hot exhaust air may be recirculated and used for fluidization. Such recirculation creates the possibility of utilizing heat energy present in the exhaust air and decreasing heat energy necessary for heating the fresh air for fluidization. The recirculated air can be, for example, purified by way of a cyclone precipitator to separate off solid particles before the purified exhaust air is combined with the fresh air.

The present invention relates to a process for producing granulated fertilizer by fluidized-bed granulation in a fluidized-bed granulator, in which the air used for fluidization in the fluidized bed is drawn in and heated before entry into the fluidized-bed granulator, with hot exhaust air exiting from the fluidized-bed granulator being obtained in the process.

Ammonium sulfate is used in many applications. For example, ammonium sulfate is used as fertilizer or fertilizer additive. Here, ammonium sulfate represents a source both of nitrogen and of sulfur, which are important plant nutrients. There is a sulfur deficiency in many soils worldwide, and this can be at least partially compensated for by targeted addition of ammonium sulfate.

The preparation of ammonium sulfate can be carried out in various ways. For example ammonium sulfate can be formed by introduction of ammonia into sulfuric acid. Industrially, ammonium sulfate is frequently crystallized from solutions obtained as by-product, for example in coal furnaces or plants for preparing caprolactam. Angular crystals which usually have a diameter of from 1 to 2 mm are mostly formed in the crystallization of ammonium sulfate.

Ammonium sulfate is usually not the only constituent of a fertilizer; rather, fertilizers comprise combinations of various plant nutrients (e.g. nitrogen, phosphorus, potassium or sulfur). In use, ammonium sulfate is therefore often mixed with other granulated fertilizers in order to produce a balanced fertilizer mixture.

However, crystalline ammonium sulfate has a number of disadvantages which make mixing of it into granulated fertilizers difficult. Firstly, the ammonium sulfate particles formed on crystallization are comparatively small; secondly, the particles often vary greatly in size. These properties make it difficult to produce physically homogeneous fertilizer mixtures comprising ammonium sulfate. However, uniform mixing and particle size distribution of the individual constituents is essential in the distribution of fertilizer mixtures. In addition, an excessively broad particle size distribution can also lead to mechanical problems in the uniform dispensing of the fertilizer mixture. Furthermore, the uptake of crystalline and granulated fertilizers into the soil proceeds at different speeds.

For these reasons, granulated fertilizers or fertilizer mixtures which can also be made ready only shortly before use by mixing of the individual constituents are being used ever more frequently. Granulated ammonium sulfate is ideally spherical and the individual particles of the granulated material have, for example, a diameter of from 2 to 4 mm. This size is guided by the granulated urea which represents the most widespread fertilizer worldwide.

Various processes for producing granulated ammonium sulfate are known in the prior art.

U.S. Pat. No. 4,589,904 describes the granulation of ammonium sulfate in drum granulation with downstream drier, with production of the solution occurring in a preneutralizer.

US 2012/0231277 relates to the production of buildup granules by fluidized-bed or spouted-bed granulation. For this purpose, granulation nuclei, which have been produced separately beforehand, are sprayed with an ammonium sulfate-containing solution and subsequently dried.

U.S. Pat. No. 5,809,664 discloses a process for the thermal treatment of animal excrements, in which gas used for fluidization is passed together with fuel and recirculated process air through a combustion chamber.

One problem in the granulation of ammonium sulfate is the formation of dust, with “dust” referring to particles having a diameter of less than 0.5 mm. The formation of dust is attributable to essentially three sources. Firstly, the nozzles which spray the solution to be granulated each produce droplets having a particular distribution of diameters, with some of the smallest droplets solidifying before they impinge on ammonium sulfate particles, so that the dust formed in this way leaves the granulator again with the exhaust air. Mention may also be made of abrasion of the granulated material owing to movements and impacts of the particles as a source of dust, for example in a fluidized bed, with the amount of dust formed depending substantially on the mechanical properties of the granulated material. Finally, the dust which is formed by mechanical breaking-up of excessively large granules, in addition to the broken particles, and which in the processes and plants according to the prior art usually goes directly back into the granulator together with the broken material may be mentioned as third source.

In the production of granulated fertilizer in a fluidized-bed granulation plant, hot exhaust air having a temperature of, for example, from about 70° C. to about 100° C. arises, and this is released into the surroundings in conventional processes. As a result, the energy present in the hot exhaust air is lost, so that the process is economically disadvantageous from the point of view of energy consumption.

It is an object of the present invention to provide an improved process for producing granulated fertilizer by fluidized-bed granulation having the features of the type mentioned at the outset, which process has a more favourable energy balance.

This object is achieved by a process according to the invention for producing granulated fertilizer by fluidized-bed granulation of the type mentioned at the outset having the features of Claim 1.

According to the invention, at least one substream of the hot exhaust air is recirculated to the granulator and used as fluidizing air. This creates the possibility of utilizing the heat energy present in the exhaust air and decreasing the heat energy necessary for heating the fresh air for fluidization.

In the context of the present invention, theoretical and experimental studies in which the possible plant configurations for heat recovery were examined with regard to product quality, economics and technical feasibility were carried out. An optimal plant configuration which is both technically feasible and in which the best economic process conditions can be implemented has been found. Finally, the influence of the altered composition of the fluidizing air and thus the influence of the process conditions during the spray granulation process in a granulator on the quality of the granulated material (residual moisture, hardness, bulk density, particle size) was examined on the laboratory scale. Limit values for the degree of recirculation of process exhaust air, at which no noticeable change in product quality occurs, were found.

Due to the exhaust air recirculation, capital costs for an air purification system and an additional circulation blower can be incurred, which increases the cost of the plant but at the same time the fresh air blower becomes up to 50% smaller, as does a heat exchanger (air preheater) and the energy consumption for preheating the fluid air becomes considerably smaller. The operating costs for, for example, steam which is frequently used for heating the air in industrial plants decrease by up to 30%.

The comparatively high operating costs of an ammonium sulfate (AS) fluidized-bed granulation plant are reduced in this way. Savings potential is achieved by this heat integration. In the case of AS spray granulation processes, considerable proportions of the energy fed to the process are otherwise discharged from the system together with the hot exhaust air having a temperature of up to 100° C. into the surroundings in conventional processes. A considerable savings potential is therefore achieved by the solution according to the invention.

In a preferred further development of the present invention, the recirculated hot exhaust air and a stream of freshly drawn in and/or optionally preheated air are mixed with one another and the mixed air produced in this way is used for fluidization.

According to the present invention, the stream of the recirculated hot exhaust air and the stream of air freshly drawn in for fluidization are preferably each fed to a heat exchanger and the heating of the freshly drawn-in air preferably occurs in the heat exchanger.

Since the heat energy present in the recirculated substream of the exhaust air is not sufficient to bring all of the fluidizing air to the intended temperature, additional heating of the air provided for fluidization by means of an external heat source or a further heat exchanger is, according to a further development of the invention, preferably provided.

In the case of an industrial plant, it is possible to use, for example, steam having a pressure in the range up to, for example, about 16 bar as external heat source. A source of steam is frequently available, since steam is used for other important industrial uses. It is also possible to utilize the heat of reaction from the neutralization of ammonia with sulfuric acid.

According to a further development of the invention, the air provided for fluidization is preferably purified, in particular to remove any solid particles in this way, before it is fed to the fluidized bed.

For this purpose, the air provided for fluidization can, for example, flow through at least one purification apparatus before it is fed to the fluidized bed.

To remove solid particles in the exhaust air, it is particularly advantageous for the air provided for fluidization to flow through at least one cyclone precipitator as purification apparatus before it is fed to the fluidized bed.

A plurality of purification apparatuses for the exhaust air before the latter is recirculated can also be connected in series, for example a cyclone precipitator and an additional filter device.

In an embodiment of the invention, existing exhaust gas streams from other (sub)plants, either in the form of direct introduction as a fluid stream for fluidization or else as heat source for indirect heating/preheating of a fluid stream for fluidization in a fluidized-bed granulator, are utilized in order to create improved heat integration of the plant for fluidized-bed granulation of a fertilizer, for example into an existing plant network. Here, purification of the exhaust gas stream provided by other (sub)plants can be necessary in a variety of forms, with, for example, separators, condensers, scrubbers, heat exchangers or other apparatuses being able to be used. Use of a substream of an available exhaust gas stream from (sub)plants for direct fluidization or else as heat source for indirect heating of a fluid air stream for use in a fluidized-bed granulator is also conceivable. Furthermore, the use of a fluid stream originating from another (sub)plant for heating a fluid air stream for use in a fluidized-bed granulation of a granulated fertilizer can be useful.

In one variant of the present invention, it is not absolutely necessary to use a recirculation of at least one substream of the hot exhaust air originating from the fluidized-bed granulator. Optionally, it may then be no longer necessary to use any blower for recirculated air and/or an air heater stage 1 and/or an air heater stage 2 and/or a fresh air blower.

The present invention further provides a plant for producing granulated fertilizer by fluidized-bed granulation, in particular according to a process of the type described above, where the plant comprises a fluidized-bed granulator, at least one conduit for feeding air for fluidization to the fluidized-bed granulator and also at least one conduit for feeding a solution containing substances for the production of the granulated material to the fluidized-bed granulator and also at least one conduit for discharging heated exhaust air from the fluidized-bed granulator, wherein, according to the invention, at least one return conduit leading from the fluidized-bed granulator is provided, by means of which conduit at least a substream of the exhaust air from the fluidized-bed granulator can be recirculated into the conduit for feeding air for fluidization to the fluidized-bed granulator.

According to a further development of the invention, this plant preferably comprises at least one purification apparatus, preferably a cyclone precipitator and/or a filter device, which are arranged in the flow path of the return conduit between the fluidized-bed granulator and the conduit for feeding air to the fluidized-bed granulator.

According to a further development of the present invention, at least one additional blower should be arranged in the flow path of the return conduit. The blower serves to bring the exhaust air stream of the recirculated exhaust air to a desired pressure, which preferably corresponds approximately to the pressure of the inflowing fresh air.

In a preferred structural variant of the invention, at least one air heater is arranged in the conduit for feeding air to the fluidized-bed granulator and the return conduit opens into the conduit upstream of this air heater. In the air heater, heating by means of steam, direct heating by means of a burner or, in relatively small plants, optionally heating using an electric air heater can be carried out. In the abovementioned routing of conduits, the hot exhaust air can advantageously firstly be mixed with preheated fresh air and the additional heating of the mixed air to the required temperature can then be carried out in a further heat exchanger.

It is advantageous for the recirculated air stream to be introduced between two heat exchangers, with the first serving as preheating stage only for the fresh air and the second serving to heat the total air stream to the process temperature.

It is advantageous for at least one fresh air blower to be arranged in the conduit for feeding air to the fluidized-bed granulator upstream of the junction with the return line, i.e. at least two blowers are generally present in a plant of the invention, namely one blower for the recirculated exhaust air and a separate blower for the freshly introduced air.

It can also, for example, be advantageous to use a further blower which is preferably arranged as sucking blower in a separate conduit for unrecirculated exhaust air which goes out from the fluidized-bed granulator, so that this exhaust air can be drawn off from the system and, after purification, be released into the environment.

Since discharge of part of the exhaust air from the plant is necessary, it is useful from environmental points of view for at least one purification stage for removing dust from the exhaust air to be provided in the conduit for unrecirculated exhaust air.

The present invention further provides for the use of a plant for producing granulated fertilizer having the above-described features in an inventive process of the type described at the outset.

A particularly preferred variant of the present invention is based on a perforated bottom plate for distributing the fluidizing medium. This distributes the fluidizing medium over the entire area of a generally (but not necessarily) rectangular apparatus, with very moderate gas velocities.

Dried animal excrements are a slurry, i.e. suspension, which optionally also comprises solids in the aqueous slurry. We work with a solution which is free of solid particles, otherwise our nozzles would become blocked.

The granulated material produced in the context of the present invention is preferably a nitrogen and sulfur fertilizer having a moisture content of less than 0.5%. The granulated material is thus inorganic in nature.

In variants of the present invention, inorganic dust constituents in the exhaust gas are separated out by deposition in cyclones (recycle gas) and in another purification unit for exhaust gas (scrubber, filter, cyclone). Incineration is of no use here.

In a further preferred variant of the present invention, the granulated material obtained is discharged from the granulator only through an overflow or star feeder. Only fine particles, if any, are present in the exhaust air and these may have to be separated off and recirculated to the granulation process; incineration would serve no purpose for these.

The temperature range of the fluidizing air is, in some variants of the present invention, preferably 180-200° C.

For the purposes of the present invention, heating can be effected by means of electric energy.

In some preferred variants of the present invention, an electric air heater or a heat exchanger operated using low-pressure or intermediate-pressure steam can be used for preheating of air. In such preferred variants of the present invention, either an electric air heater or a heat exchanger operated using intermediate-pressure steam can likewise be used for heating the total air stream composed of recirculated air and/or fresh air and/or exhaust air from other (sub)plants to the target temperature.

In one variant of the present invention, the heating of the gas is not carried out by means of a combustion chamber, an incinerator or a similar apparatus.

In one variant of the present invention, hot, suitable exhaust air streams from other (sub)plants can be used as an alternative to or in addition to the drawn-in fresh air, either directly as fluidizing stream for fluidization or else as heat source for heating/preheating a fluid stream for the fluidization in the fluidized-bed granulator.

In one variant of the present invention, the plant is a fertilizer production plant; in this variant, the various features of the matters described for the plants of the invention and for the process of the invention can be used in an identical manner.

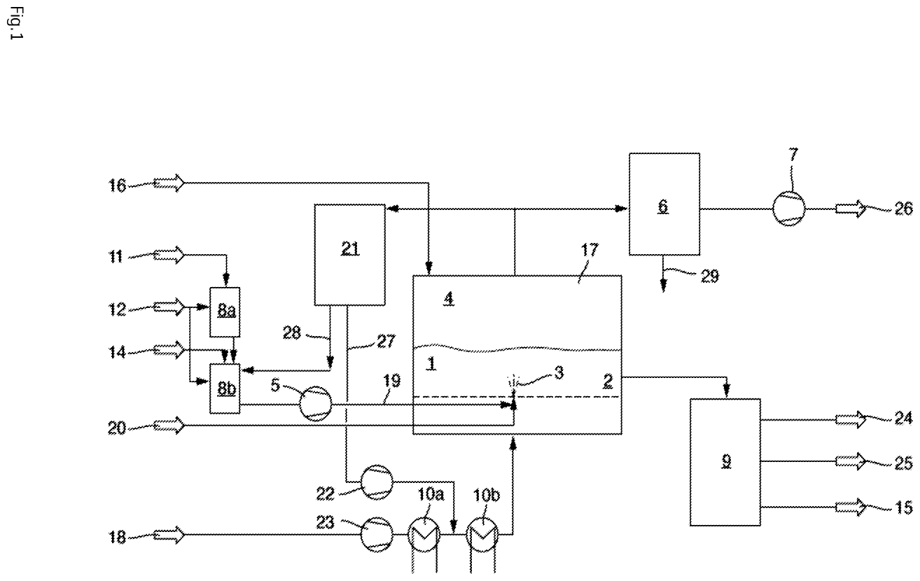

A working example of the present invention will be explained in more detail below with reference to FIG. 1. Here:

FIG. 1 shows a flow diagram of an illustrative granulation plant for producing granulated fertilizer with heat recovery according to the present invention.

In the following, a possible working example of the present invention will be explained in more detail with reference to FIG. 1. The depiction shows a flow diagram of an illustrative granulation plant which is used for producing granulated fertilizer according to the invention. This plant is a type of plant which is designed, in particular, for the production of relatively small amounts of granulated fertilizer. A fluidized-bed granulator 17 is used for producing the granulated material. In this plant, the air used for fluidization is drawn in from the surroundings by a blower 23 and flows via the conduit 18 and through an inflow plate 2 into the process chamber 1. Before entry into the process chamber, the air passes through electric air heaters 10a, 10b. Spray nozzles 3 which are installed in the “bottom spray” configuration and spray the solution vertically upwards in cocurrent with the fluidizing air are located in the process chamber 1. The spray nozzles 3 are supplied via the conduit 20 with compressed air used as atomizing air.

The spray solution can be prepared batchwise in containers 8. Granulation additives can be dissolved in a first container 8a or be placed in the container as solution. The granulation additives are introduced via a conduit 11 into this first container 8a. Water for adjusting the concentration can be introduced via a further conduit 12 into this first container 8a.

The ammonium sulfate solution is prepared in a second container 8b. Water is firstly fed via a branched conduit 13 connected to the conduit 12 into this second container 8b and the ammonium sulfate (AS) is introduced as solution or more rarely in crystal form via a further conduit 14 into the second container 8b. The appropriate amount of additive solution is subsequently metered from the first container 8a into the second container 8b containing the AS solution. In some cases, the additive can also be introduced in crystal form into the AS solution. The solution is homogenized by means of a stirrer and preheated to the process temperature by means of a heating device. The solution is then conveyed by means of a pump 5 through the conduit 19 into the fluidized-bed granulator 17 at the nozzles 3.

Above the process chamber 1, there is an expansion chamber 4 which has a greater apparatus cross section than the process chamber 1. As a result of the increased cross section, the air velocity is reduced and discharge of the small particles from the system is reduced in this way. The exhaust air goes into an external purification unit 6 and is there freed of particles which have been discharged from the granulator 17. A blower 7 is located downstream of the purification stage, so that the entire plant is operated in suction mode (subatmospheric pressure). The granulated material taken off is classified by means of a sieve plant 9 into the three fractions oversize, product and undersize. The undersize material sieved off (fines) is recirculated via the conduits 15, 16 and introduced together with additional nucleus material into the granulator.

According to the invention, only a purified substream of the exhaust air is optionally discharged via conduit 26 from the system, while a further substream is recirculated in order to utilize the heat energy present in the exhaust air. For this purpose, a branch is provided in the exhaust air conduit leaving the granulator 17, so that this substream to be recirculated can be conveyed via the conduit pointing to the left in the drawing to a purification apparatus 21, which is, for example, a cyclone precipitator by means of which solid particles can be precipitated from the exhaust air stream. The solids particles separated off there can, for example, be conveyed via conduit 28 back to the container 8b in which the preparation of the granulation solution is carried out. A substream of the recirculated exhaust air purified in this cyclone precipitator 21 is then conveyed via a conduit 27 and a blower 22 into the conduit 18 via which the air for fluidization goes into the process chamber 1, with the introduction of the recirculated exhaust air preferably occurring downstream of the fresh air blower 23 and air heater 10a and upstream of the air heater 10b. The advantage of the use of the recirculated exhaust air is that heat energy is still stored in this, so that after combining with the fresh air which is fed in from the outside and has been partially heated in the air heater 10a downstream of the blower 23, further heating of the introduced fresh air by the hot exhaust air occurs. As a result, the energy required for heating the total air for fluidization by means of the air heater 10b is reduced.

At the same time, the streams 18 and 26 are decreased by recirculation of a substream. As a result, the requirements having to be met and the power uptakes of the blowers 7 and 23 and also the purification unit 6 are reduced.

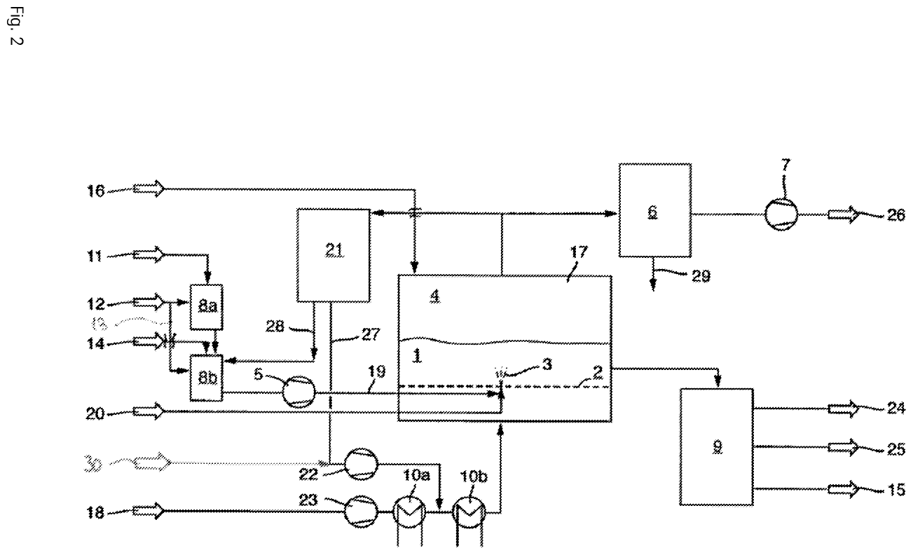

FIG. 2 shows an alternative embodiment in which, as an alternative to or in addition to the drawn-in fresh air, hot, suitable exhaust gas streams 30 from other (sub)plants are mixed with the recirculated stream in conduit 27.

### LIST OF REFERENCE NUMERALS

1 Process chamber

2 Inflow plate

3 Spray nozzles

4 Expansion chamber

5 Pump

6 Purification unit

7 Exhaust air blower

8a First container

8b Second container

9 Sieving

10a Air heater or heat exchanger stage 1

10b Air heater or heat exchanger stage 2

11 Conduit for addition of the additives

12 Conduit for addition of water

13 Conduit for addition of water

14 Conduit for addition of the ammonium sulfate

15 Conduit for recirculation of the fines

16 Conduit for recirculation of the fines

17 Granulator

18 Conduit for fresh air

19 Conduit for introduction of solution into the granulator

20 Conduit for compressed air

21 Purification of the recirculated air (cyclone)

22 Blower for recirculated air

23 Fresh air blower

24 Conduit for coarse particles (to the crusher)

25 Conduit for granulated product

26 Conduit for purified exhaust air

27 Conduit for recirculated air

28 Conduit for separated-off solid particles

29 Conduit for separated-off solid particles

30 Conduit for exhaust gas stream from other (sub)plants

1.-22. (canceled)

23. A process for producing granulated fertilizer by fluidized-bed granulation in a fluidized-bed granulator, the process comprising:
drawing in and heating air used for fluidization in a fluidized bed before the air enters the fluidized-bed granulator;
obtaining heated exhaust air exiting the fluidized-bed granulator; and
recirculating a substream of the heated exhaust air to heat the air that is drawn in and used for fluidization.

24. The process of claim 23 comprising mixing the substream of the heated exhaust air that is recirculated with the air that is drawn in to form mixed air that is used for fluidization.

25. The process of claim 23 comprising feeding the substream of the heated exhaust air that is recirculated and the air that is drawn in to a heat exchanger, wherein the heating of the air that is drawn in occurs at least partially in the heat exchanger via the substream of the heated exhaust air that is recirculated.

26. The process of claim 23 comprising at least one of
partially mixing with the air that is drawn in or replacing the air that is drawn in by an exhaust gas stream from a plant;
preheating the air that is drawn in via heat of a fluid stream that originates from a plant; or
mixing exhaust gas streams from plants with the substream of the heated exhaust air that is recirculated in a conduit.

27. The process of claim 23 comprising:
feeding the substream of the heated exhaust air that is recirculated and the air that is drawn in to a first heat exchanger where the air that is drawn in is heated by the substream of the heated exhaust air; and
feeding the substream of the heated exhaust air that is recirculated and the air that is drawn in to a second heat exchanger where the air that is drawn in is heated by a source other than the substream of the heated exhaust air.

28. The process of claim 23 comprising heating the air that is drawn in by a source other than the sub stream of the heated exhaust air.

29. The process of claim 23 comprising heating the air that is drawn in with steam having a pressure up to 16 bar.

30. The process of claim 23 comprising heating the air that is drawn in with a fuel gas that heats a burner.

31. The process of claim 23 comprising purifying the air that is drawn in prior to feeding the air to the fluidized bed.

32. The process of claim 31 comprising causing the air that is drawn in to flow through a purification apparatus and/or a filter device before the air is fed to the fluidized bed.

33. The process of claim 31 comprising causing the air that is drawn in to flow through a first purification apparatus and a second purification apparatus before the air is fed to the fluidized bed.

34. The process of claim 31 comprising causing the air that is drawn in to flow through a cyclone precipitator as a purification apparatus before the air is fed to the fluidized bed.

35. The process of claim 31 comprising causing the air that is drawn in to flow through a cyclone precipitator as a first purification apparatus and then through a filter device as a second purification apparatus before feeding the air to the fluidized bed.

36. A plant for producing granulated fertilizer by fluidized-bed granulation, the plant comprising:
a fluidized-bed granulator;
a first conduit for feeding air for fluidization to the fluidized-bed granulator;
a second conduit for feeding a solution containing substances for production of granulated material to the fluidized-bed granulator;
a third conduit for discharging heated exhaust air from the fluidized-bed granulator; and
a return conduit leading from the fluidized-bed granulator, wherein by way of the return conduit a substream of the heated exhaust air is configured to be recirculated into the first conduit.

37. The plant of claim 36 comprising a purification apparatus disposed in a flow path of the return conduit between the fluidized-bed granulator and the first conduit.

38. The plant of claim 36 comprising a blower disposed in a flow path of the return conduit.

39. The plant of claim 36 comprising an air heater disposed in the first conduit, wherein the return conduit opens into the first conduit upstream of the air heater.

40. The plant of claim 36 comprising a fresh air blower disposed in the first conduit upstream of a junction with the return conduit.

41. The plant of claim 36 comprising:
a separate conduit for a non-recirculated portion of the heated exhaust air, the separate conduit extending out from the fluidized-bed granulator; and
a sucking exhaust air blower disposed in the separate conduit.

42. The plant of claim 41 comprising a purification stage disposed in the separate conduit for purifying the heated exhaust air to be discharged.

43. A process for producing granulated fertilizer by fluidized-bed granulation in a fluidized-bed granulator, the process comprising:
drawing in and heating fluid for fluidization in a fluidized bed before the fluid enters into the fluidized-bed granulator; and
at least one of
the fluid originates from an exhaust gas stream of a plant,
air drawn in for fluidization in the fluidized bed is at least partly mixed with an exhaust gas stream of a plant, or
a part of an exhaust gas and/or a fluid stream from a plant is used for indirect preheating of the fluid for fluidization.
